(19) United States
(12) Patent Application Publication
(10) Pub. No.: US 2017/0357774 A1
(43) Pub. Date: Dec. 14, 2017

(54) AUTOMATED PRESCRIPTION COMMUNICATION SYSTEM AND METHOD

(71) Applicant: David FIGG, Beaver Dam, KY (US)

(72) Inventor: David FIGG, Beaver Dam, KY (US)

(21) Appl. No.: 15/617,794

(22) Filed: Jun. 8, 2017

Related U.S. Application Data
(60) Provisional application No. 62/347,305, filed on Jun. 8, 2016.

(51) Int. Cl. G06F 19/00

(52) U.S. Cl. CPC G06F 19/3456

(57) ABSTRACT

The invention relates to an automated system and method of communication between a pharmacy and a patient, preferably via text messaging, voice messaging or email. According to an exemplary embodiment, the system and method of the invention automatically notifies a patient in real-time when a pharmacy receives a prescription from the patient's prescriber. The system and method of the invention provides the patient with an opportunity to respond with their plans for the prescription such as to allow a patient to dictate their desired pickup time for the prescription or alert the pharmacy that they don't want the prescription filled at all for example.

### CROSS REFERENCE TO RELATED APPLICATION AND CLAIM TO PRIORITY

This application is related to Provisional Application No. 62/347,305, filed Jun. 8, 2016 in the United States of America, the disclosure of which is incorporated herein by reference and to which priority is claimed.

### TECHNICAL FIELD

The invention relates generally to systems and methods of automated communication between pharmacies and patients about the patients' health care, and, more particularly, to an automated system and method for communicating prescription information between a pharmacy and a patient by wired or wireless communication systems, such as by mobile phone, landline phone or email. In particular, the system and method of the invention relate to an automated system that automatically alerts a patient by phone (voice or text) or email when a pharmacy receives a prescription from a prescriber and allows the patient to respond with how the prescription should be handled, i.e., fill immediately, fill later, hold until further notice, etc.

### BACKGROUND

Prescription medications are prescribed to patients by a provider for a wide variety of reasons. Traditionally, prescriptions are written on paper, although electronic prescription systems have become more common. Paper prescriptions require a patient to deliver their prescriptions to a pharmacy. Electronic prescriptions allow a provider to electronically send a prescription to a pharmacy or other entity that fills prescriptions, such as a pharmacy benefits manager. After a prescription is issued by a provider, it may be filled at a pharmacy or other health care facility or service. However, patients often have no way of knowing when their prescriptions have been received by their pharmacy or the status of the prescriptions. Current systems and methods fail to effectively and conveniently help patients fully manage their prescriptions.

Alert Solutions, www.alertsolutions.com, alerts a patient when a refill is due based on the date that the last prescription was filled so that the patient does not miss a dose. Some pharmacies have systems that alert patients when a prescription has been filled and is ready for pick up so that the patient will not have to wait at the pharmacy for the prescription to be filled, see www.cubpharmacies.com. Many pharmacies have systems that combine these functionalities, i.e., they alert a patient when a prescription is ready for pick up and a refill is due, see e.g., www.cvs.com, www.schultzpharmacyrx.com, www.telemanager.com, www.walgreens.com.

US Publication 2011/0257989 to Kumar discloses systems and methods for managing prescription-related health care data for a patient using a mobile communication device. In one embodiment, a method includes identifying prescription status data for a prescription associated with a patient. The patient is a user of a mobile communication device. The method also includes determining whether the prescription is ready for retrieval from a pharmacy using the prescription status data, and initiating a prescription availability notification on the mobile communication device in response to determining that the prescription is ready for retrieval from the pharmacy. The prescription availability notification notifies the patient that the prescription is ready for retrieval from the pharmacy. The method also includes presenting a set of selectable modules on a graphical user interface of the mobile communication device. At least a portion of the set of selectable modules is related to the prescription. In other words, Kumar communicates with a patient when a prescription is ready for pickup.

However, none of these systems or methods alert a patient at the time a prescriber sends a prescription to a pharmacy. This is often a time of confusion for the patient, because the patient doesn't have control over the prescription and doesn't know when it will be received by the pharmacy. Accordingly, there remains a need to provide a system and method that alerts a patient earlier in the prescription filling process; that is, at the time when a provider sends a prescription to a pharmacy to be filled.

### SUMMARY

It is a first aspect of the invention to provide a HIPAA (Health Insurance Portability and Accountability Act of 1996) compliant, automated system and method of communication between a pharmacy and a patient, preferably via text messaging, voice messaging or electronic mail.

It is a second aspect of the system and method of the invention to notify a patient in real-time when a pharmacy receives a prescription from a prescriber.

It is a third aspect of the invention to provide a patient with an opportunity to respond with his/her plans for a prescription once notified that a pharmacy has received the prescription, such as to allow the patient to dictate the desired pickup time for the prescription or alert the pharmacy that the prescription is not to be filled at all.

It is a fourth aspect of the invention to provide a method for automated communication of prescription information between a pharmacy and a patient, the method comprising the steps of receiving a prescription for the patient from a prescriber, determining whether the patient has opted into receiving notifications, determining whether the patient has opted into bi-directional notifications, retrieving a notification message and valid responses from storage, determining whether the message has a valid response, notifying the patient that the prescription has been received, and determining whether a valid response was received within an allotted time.

It is a fifth aspect of the invention to provide an automated prescription communication system for communicating prescription information to a patient, the prescription communication system comprising an electronic prescribing system, the electronic prescribing system comprising prescription information for the patient, a communication unit comprising a table of messages and appropriate responses, the messages and responses associated with the prescription information for the patient, and a prescription communication application executable on an electronic device associated with the patient, the prescription communication application comprising a module to retrieve the prescription information and to provide the prescription information to the patient on the electronic device, wherein the prescription information comprises information on when a new or refill prescription is received from a prescriber.

Other aspects of the invention, including processes, systems, and the like that constitute part of the invention, will become more apparent upon reading the following detailed description of the exemplary embodiments.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention.

FIG. 1 is a schematic representation of a system and method for automated communication of prescription information between a pharmacy and a patient according to an exemplary embodiment.

FIG. 2 is a block diagram of a system and method for automated communication of prescription information between a pharmacy and a patient according to an exemplary embodiment.

FIG. 3 is a block diagram of a system and method for automated communication of prescription information between a pharmacy and a patient according to an exemplary embodiment.

FIG. 4 is a block diagram of a system and method for automated communication of prescription information between a pharmacy and a patient according to an exemplary embodiment.

FIGS. 5A and 5B are a flowchart of a system and method for automated communication of prescription information between a pharmacy and a patient according to an exemplary embodiment.

FIG. 6 is a table of messages and appropriate responses for the automated communication of prescription information between a pharmacy and a patient according to an exemplary embodiment.

### DETAILED DESCRIPTION OF THE PREFERRED EMBODIMENT(S)

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods. Like reference characters refer to like parts throughout the drawings.

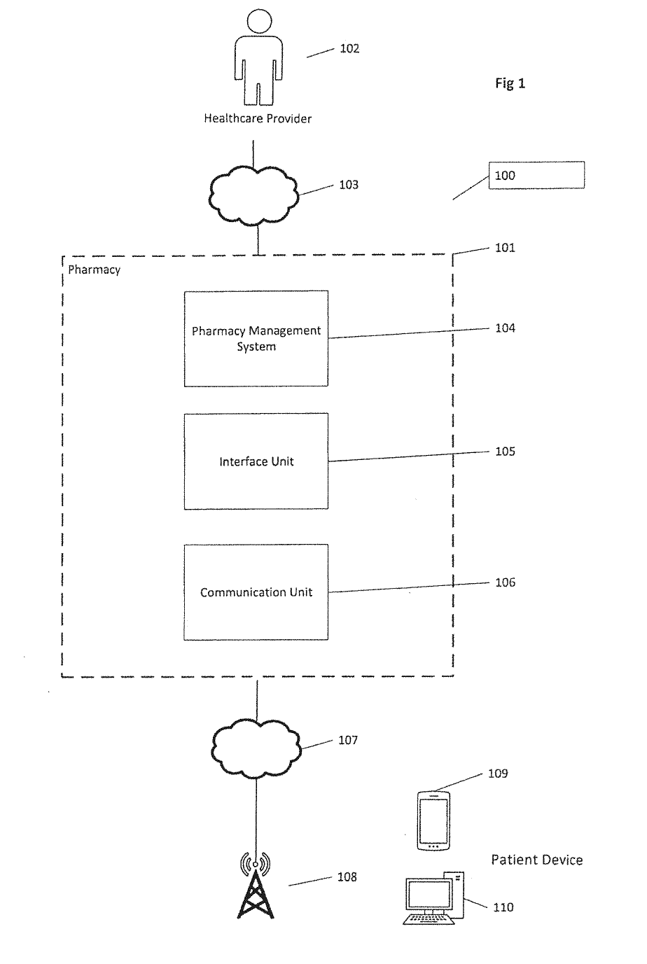

FIG. 1 is a schematic representation of a system and method 100 for automated communication of prescription information between a pharmacy 101 and a patient according to an exemplary embodiment. According to the exemplary embodiment, a healthcare provider 102 submits, preferably electronically 103, a prescription to a pharmacy 101 or other entity that fills prescriptions. The prescription is entered into the pharmacy's pharmacy management system (PMS) 104. Alternatively, the provider 102 may transmit the prescription to the pharmacy 101 by phone or fax, at which point the pharmacy 101 enters the prescription into the PMS 104. The PMS 104 is in connection with a communication unit 106 via an interface unit 105. The interface unit 105 provides a bi-directional interface between the PMS 104 and the communication unit 106. The communication unit 106 in turn transmits 107 prescription information from the PMS 104 to a patient's device, such as a mobile phone 109 or computer 110, preferably via wireless communication 108, such as by CDMA, GSM, 3G, 4G, Edge, an over-the-air network, Bluetooth, etc.

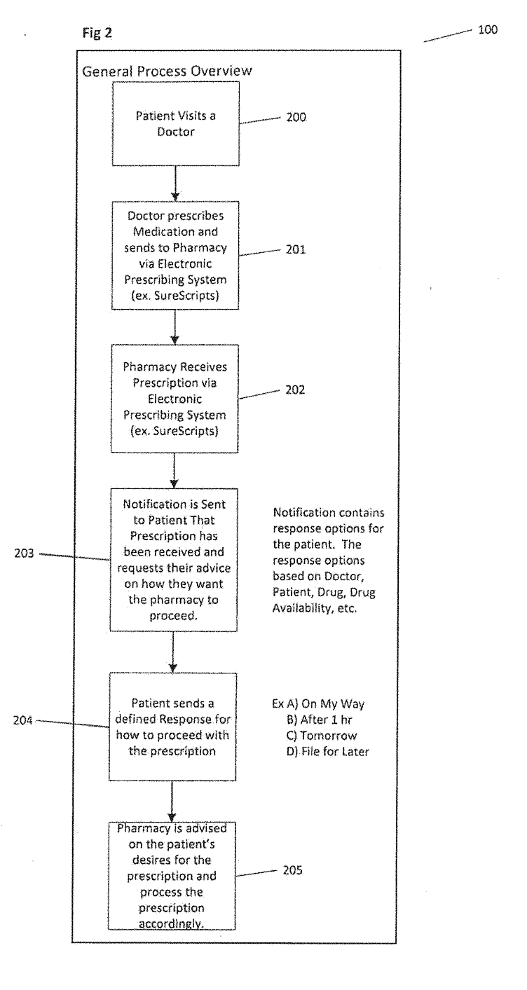

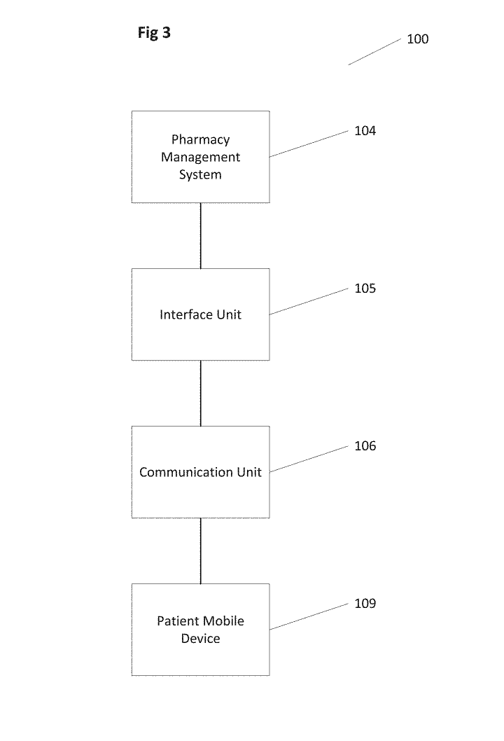

FIG. 2 is an overview of a system and method 100 for automated communication of prescription information between a pharmacy and a patient according to an exemplary embodiment. When a patient is seen by a medical professional, such as a physician, a physician's assistant, a nurse, etc. at step 200, the medical professional may prescribe a medication. Prescribers often use electronic prescription systems, i.e., an e-prescription system such as SureScripts®, to electronically transmit prescription information to the patient's pharmacy's PMS at step 201. The system and method of an exemplary embodiment monitors the pharmacy's PMS for new or refill prescriptions that are received at step 202. As discussed above, prescriptions may optionally also be received by fax or phone or other method from a prescriber and manually entered into the PMS.

For patients that have opted into the automated system 100, once a new or refill prescription is received from a prescriber and entered into the PMS, the relevant patient is notified in real time of same by Short Message Service (SMS), iMessage, Custom Mobile App, Interactive Voice Response (IVR), or email at step 203. Preferably, the system notifies the patient by SMS or IVR, such that the patient does not need to download application software and can use any mobile phone or landline phone, as appropriate, to communicate with their pharmacy.

In the notification, the patient is given a series of options with which to respond at step 204. For example, options for a reply can include, 1) on my way; 2) pick up within the hour; 3) pick up tomorrow; or 4) do not fill at this time. The patient's response is then transmitted to the PMS, alerting them of the proper handling of that prescription at step 205.

If the patient does not respond within an allotted time, such as 30 minutes, 15 minutes, 10 minutes, 5 minutes or the like, the prescription continues through the standard fill process, but is not expedited. If the patient does not respond to the notification at all, the prescription is filled through the standard process.

According to another exemplary embodiment, the system and method also alerts patients when they have prescriptions that have not been picked up within a certain period of time, i.e., a certain number of days, preferably 2-7 days, preferably 3-5 days, more preferably 3 days. The system and method may also optionally alert a patient when it is time to refill a prescription or take their medication, with or without the ability for bi-directional communication.

As seen in FIG, 3, in the system and method of an exemplary embodiment, the PMS 104 communicates prescription information to the communication unit 106 via the interface unit 105. The communication unit 106, in turn communicates the prescription information to a patient device, such as a mobile phone 109. In other words, the communication unit 106 handles the bidirectional communication and messaging with a patient's device, such as a patient's mobile phone 109.

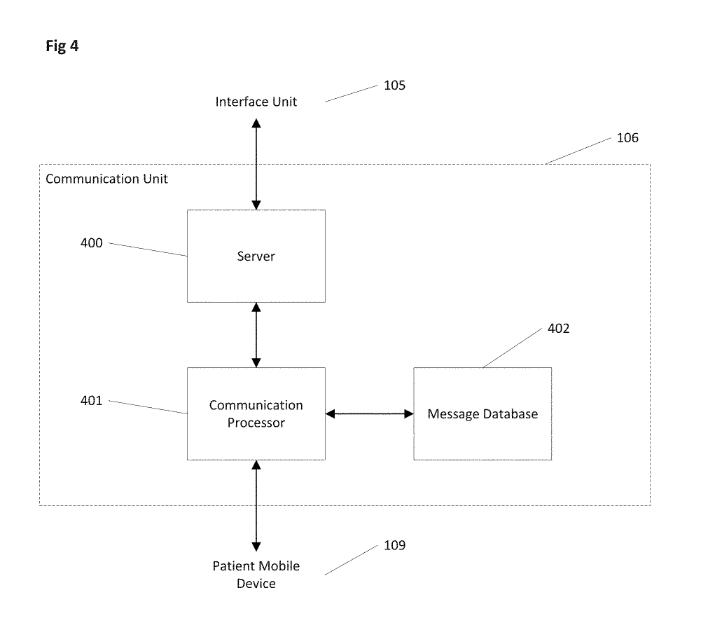

The communication unit 106 includes a server 400, a communication processor 401 and a message database 402 as seen in FIG. 4. The message database 402 includes the communication messaging definitions. The communication processor 401 sends and receives communications from the patient's device.

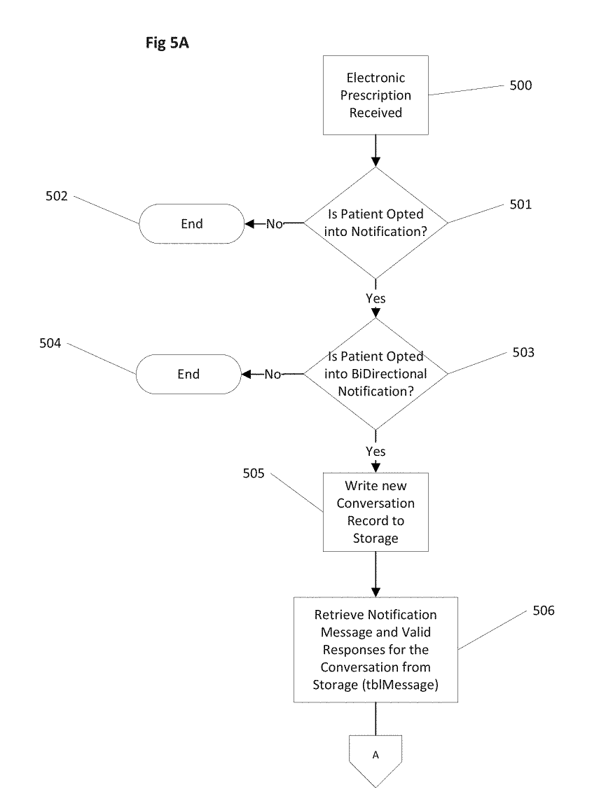

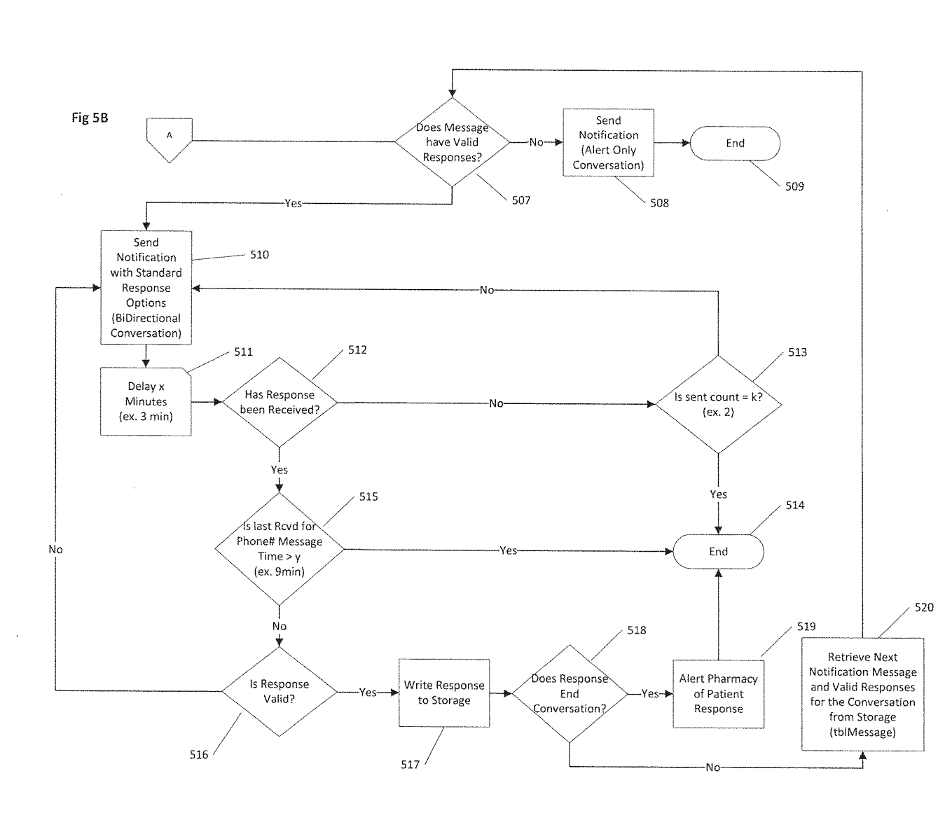

Turning now to FIGS. 5A and 5B, when the electronic prescription is received by the PMS at 500, the automated system 100 determines whether the patient has opted into notifications at 501. By default, a patient is not enrolled in the notification system. According to an exemplary embodiment, a patient must affirmatively opt into the notification system at 501 by requesting enrollment with the pharmacy, either verbally or in writing. The pharmacy then marks the patient's profile for notification in the PMS. A patient can opt out of the system at any time by notifying the pharmacy directly, verbally or in writing, or through the automated system 100.

If the patient has not opted into notification, the automated system 100 terminates at 502. If the patient has opted into notification, the automated system 100 determines if the patient has specifically opted into bi-directional communication at 503. If the patient has opted into notifications, but not bi-directional communication 503, the automated system 100 terminates at 504. The notifications and alerts are written to storage each time a message is sent at 505 or received at 517 by the automated system 100.

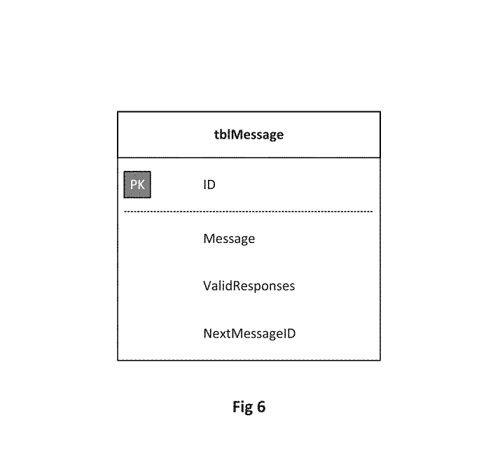

The automated system 100 then retrieves the appropriate messages and valid responses from storage at 506. As best seen in FIG. 6, the automated system 100 includes a table of messages and appropriate responses in a database for retrieval, which includes at least the following fields: 1) message to send, 2) appropriate responses, and 3) indicate next message to send or to terminate.

The automated system 100 then determines if a message has a valid response in the database at 507. If there is no valid response in the database, a notification is sent to the patient, but the patient is not given the opportunity to respond at 508 and the automated system 100 at terminates 509. If the automated system 100 determines that the message has a valid response in the database, a notification is sent to the patient with response options at 510. The automated system 100 then waits for a response for a defined time, x, at 511. According to an exemplary embodiment, the defined or response time, x, is about 2-7 minutes, preferably about 3-5 minutes, more preferably about 3 minutes. If no response is received within the allotted response time, x, at 512, the automated system 100 determines how many times k the message has been sent at 513. If the message has been sent fewer than k times, the message is resent at 513. If the message has been sent at least k times, the automated system 100 terminates at 514. According to an exemplary embodiment, k is preferably 2 or 3, preferably 2 times. In other words, system 100 will send the message 2-3 times seeking a response, and will terminate messaging if no response is timely received after the predetermined number of messages have been sent without response.

If a response is received, the automated system 100 then determines whether the response was received after y time at 515. According to an exemplary embodiment, y time is about 5-15 minutes, preferably about 7-12 minutes, more preferably about 10 minutes. If the response was received after y time, the automated system 100 terminates at 514. If the response is received before y time, the automated system 100 determines if the response is valid at 516. If the response is not valid, the automated system resends the message at 510 and the automated system 100 repeats the process of sending a notification. If the response is valid, the automated system 100 determines if the response terminates the conversation at 518. If the response terminates the conversation, the pharmacy is so notified via the PMS at 519 and the automated system 100 terminates at 514. If the response does not terminate the conversation, the automated system retrieves the next message and response at 520, determines whether the message has a valid response at 507, and the automated system 100 repeats the process.

Exemplary automated messages may include, for example:

Pharmacy received a Prescription. Please text/respond pickup option:

A=On my way

B=After hh:mm (wherein hh:mm is the time about 15-180 minutes, preferably about 20-120 minutes, preferably about 20-60 minutes, preferably about 25-45 minutes, more preferably about 30 minutes, from the time the message was sent)

C=Tomorrow

D=Fill later

According to another exemplary embodiment, the system and method may also include additional notifications, i.e., insufficient inventory to fill at this time; alternative response options, i.e., fill on (future date); authorize 3^{rd} party pick up; or follow-up notifications, i.e., original prescription required, insurance card required at pickup, etc. Table 1 lists additional messages that are optionally included in the system and method.

TABLE 1
Additional Notifications/messages

| Notifications | Description | Responses |
|---|---|---|
| Pickup alerts | Sends a notification to a | A = Pickup today |
| & reminders | patient that they have a | B = Pickup this week or |
| | prescription ready for | Pickup on [Date] |
| | pickup | C = Deliver |
| | | D = Don't need |
| Refill | Sends a notification to a | A = Fill |
| reminders | patient to remind them of | B = Fill tomorrow |
| | an upcoming prescription | C = Don't fill yet |
| | refill that has remaining | Optional additional response |
| | refills | D = Fill on [Date] |
| Rx renewal | Sends a notification to a | A = Request refill from |
| alert | patient that a prescription is | prescriber |
| | due for a refill in a certain | B = Appointment with |
| | number of days, i.e., 5 | prescriber before date refill is |
| | days, 7 days, 14 days, or 21 | due |
| | days, but that there are no | C = Do nothing at this time |
| | remaining refills | |
| Return to | Sends a notification to a | A = Pickup today |
| stock alert | patient that they have had a | B = Pickup this week or |
| | prescription ready for pick- | Pickup on [Date] |
| | up for a certain number of | C = Deliver |
| | days, i.e., 5 days, 7 days, | D = Don't need |
| | 14 days, or 21 days and re- | |
| | quests a response or pre- | |
| | scription will be returned | |
| | to stock | |
| Rx on file | Sends a notification to a | A = Please fill |
| not filled | patient that they have a | B = Keep on file |
| | prescription that has been | C = Discontinue prescription |
| | on file for more than a | |
| | certain amount of time, i.e., | |
| | a month, that has never | |
| | been filled | |
| Medication | Sends a notification to a | Initial response |
| synchroni- | patient enrolled in a | A = Today |
| zation | medication synchronization | B = Tomorrow |
| update alert | program that their | C = In 2 days |
| | prescription is due to be | Optionally, D = On [date] |
| | filled in certain number of | Follow-up response |
| | days, i.e., 3 days, 5 days or | Indicate time (hh:mm) for the |
| | 7 days, and allows them to | date selected |
| | respond with a day and | |
| | time to schedule a call to | |
| | discuss the details | |

A medication synchronization program allows a pharmacy to coordinate refills of various prescriptions so that they can be picked up on a single day each month. Patients are given the option to enroll verbally, in writing or through the automated system 100. Once enrolled, the pharmacy will review the various prescriptions and develop a plan to synchronize them so they can be picked up on a single day each month that is convenient for the patient. About a week before the prescriptions are due to be refilled each month, the automated system sends a notification to the patient to confirm the pickup date and identify any changes that need to be made before the prescriptions are refilled. After reviewing the changes to the prescriptions, the pharmacy prepares the prescriptions and creates one package for easy pick up on the scheduled pickup date. On the scheduled day, the patient picks up all of the prescriptions at the pharmacy. At that time, they patient can ask the pharmacist any questions that he/she may have about the prescriptions. The process repeats itself each month so that the patient can pick up all of the prescriptions at once, and the pharmacy can identify potential issues to help the patient take the prescriptions as prescribed.

Optionally, the system and method provide prescription workflow status notifications. This feature sends a notification to a patient asking if the patient wants to subscribe to workflow status. If a patient elects not to subscribe to the notifications, no prescription workflow status notifications are sent. If a patient elects to subscribe to the notifications, the system and method send notifications each time the prescription moves through the fill process, i.e., Entry, Fill, Quality Control, Completion, or Clinical delay, wherein Clinical delay means that something needs to be verified with the prescriber.

The system and method of the invention is HIPPA compliant because there is no personal health information (PHI), such as patient name, date of birth, social security number, prescription information, etc. in the messages.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to limit the invention to the precise embodiments disclosed. The specification describes exemplary embodiments to accomplish a more general goal that may be accomplished in another way.

1. A method for automated communication of prescription information between a pharmacy and a patient, the method comprising the steps of:
i. receiving a prescription for the patient from a prescriber,
ii. determining whether the patient has opted into receiving notifications,
iii. determining whether the patient has opted into bi-directional notifications,
iv. retrieving a notification message and valid responses from storage,
v. determining whether the message has a valid response,
vi. notifying the patient that the prescription has been received, and
vii. determining whether a valid response was received within a specified time.

2. The method of claim 1, further comprising the step of requesting patient enrollment into receiving notifications.

3. The method of claim 1, wherein the prescription information is received through an electronic prescription system.

4. The method of claim 3, further comprising the step of monitoring the electronic prescription system for prescription information.

5. The method of claim 1, including the step of notifying the patient through one of Short Message Service (SMS), iMessage, Custom Mobile Application, Interactive Voice Response (IVR), or email communication.

6. The method of claim 1, further comprising the step of writing the notifications and responses into storage.

7. The method of claim 1, wherein the time specified to receive a valid response comprises 9 minutes.

8. The method of claim 1, further comprising the step of resending the notification if a valid response is not received within the specified time.

9. The method of claim 8, wherein the step of resending the notification repeats at least once.

10. The method of claim 1, further comprising the step of notifying the patient of prescriptions that are ready for pickup, prescriptions that are due for refills, prescriptions that are out of refills, prescriptions that will be returned to stock, or prescriptions that have not been filled.

11. The method of claim 1, further comprising the step of notifying the patient of prescription workflow status.

12. An automated prescription communication system for communicating prescription information to a patient, the prescription communication system comprising:
an electronic prescribing system, the electronic prescribing system comprising prescription information for the patient,
a communication unit comprising a table of messages and appropriate responses, the messages and responses associated with the prescription information for the patient, and
a prescription communication application executable on an electronic device associated with the patient, the prescription communication application comprising a module to retrieve the prescription information and to provide the prescription information to the patient on the electronic device,
wherein the prescription information comprises information on when a new or refill prescription is received from a prescriber.

13. The system of claim 12, wherein the electronic device comprises a phone or a computer.
